(19) United States
(12) Patent Application Publication
(10) Pub. No.: US 2009/0153586 A1
(43) Pub. Date: Jun. 18, 2009

(54) Method and apparatus for viewing panoramic images

(76) Inventors: Gehua Yang, Clifton Park, NY (US); Charles Stewart, Clifton Park, NY (US)

Correspondence Address: RAYMOND R. MOSER JR., ESQ.;MOSER IP LAW GROUP, 1030 BROAD STREET, 2ND FLOOR, SHREWSBURY, NJ, 07702, US

(21) Appl. No.: 12/291,168

(22) Filed: Nov. 6, 2008

Related U.S. Application Data
(60) Provisional application No. 61/002,183, filed on Nov. 7, 2007.

(51) Int. Cl. G09G 5/00

(52) U.S. Cl. 345/629

(57) ABSTRACT

A method and apparatus for viewing panoramic images comprising a panorama viewer which further comprises at least two layers with each layer corresponding to a point of time within an interval during which a set of images are taken. Each layer is constructed by taking into account only the images taken at the point of time. A time dimension control is included to allow a user to navigate through the panorama based on relative time of occurrence.

### CROSS-REFERENCE TO RELATED APPLICATIONS

This application claims benefit of U.S. provisional patent application Ser. No. 61/002,183, filed Nov. 7, 2007, which is herein incorporated by reference.

### BACKGROUND OF THE INVENTION

1. Field of the Invention

Embodiments of the present invention generally relate to computer vision systems, and more particularly, to a method and apparatus for viewing panoramic images wherein a control is included in a panorama viewer that allows a user to navigate through portions of the panorama, viewing images based on relative time of occurrence.

2. Description of the Related Art

A panorama is stitched together from a set of overlapping images with the restriction that the images must be either taken from one location or be taken of a scene that can be approximated by a planar surface [R. Hartley and A. Zisserman. Multiple View Geometry. Cambridge University Press, 2000]. During the construction of a panorama, images are first aligned with each other, either manually or automatically [M. Brown and D. Lowe, Recognising panoramas. In Proc. ICCV, 2003]. Second, colors of the pixels corresponding to the same physical location are combined to produce the color of that location on the panorama. The resulting panorama can be deemed as a huge image spanning across all the images. The panorama usually requires a special software program to allow viewing on a computer screen. This is due to the exceedingly large resolution usually associated with a panorama. The required software program is referred to as a “panorama viewer”.

A panorama viewer is usually composed of two parts: one part is the image area (usually dominating), which displays a portion of the panorama currently under examination. The second part is the control area, which controls on the location and the size of the image area of the panorama. Typically, the control area has six controls—left, right, up, down, zoom in, and zoom out. No facility is provided to allow a user to select images based on relative time of occurrence in the panorama.

### SUMMARY OF THE INVENTION

The present invention generally relates to a panorama viewer that includes a time dimension control. One embodiment of the present invention is a panorama viewer comprising multiple (at least two) layers with each layer corresponding to a point of time within an interval during which a set of images are taken. Each layer is constructed by taking into account only the images taken at the point of time. The alignment of images taken at different times brings multiple layers into aligned positions. The system also includes an image area and a control area. The control area comprises, still further, an up control, a down control, a zoom in control, a zoom out control, a left control, a right control, and a time dimension control.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a computer system according various embodiments of the present invention;

FIG. 2 is block diagram of a 4D panorama viewer according to the present invention; and

FIG. 3 is a flow chart of a method for constructing a 4D panorama viewer that comprises a time dimension control in accordance with the present invention.

While the invention is described herein by way of example using several embodiments and illustrative drawings, those skilled in the art will recognize that the invention is not limited to the embodiments of drawing or drawings described. It should be understood that the drawings and detailed description thereto are not intended to limit the invention to the particular form disclosed, but on the contrary, the invention is to cover all modification, equivalents and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. Further, the word “a” is used to mean at least one.

### DETAILED DESCRIPTION

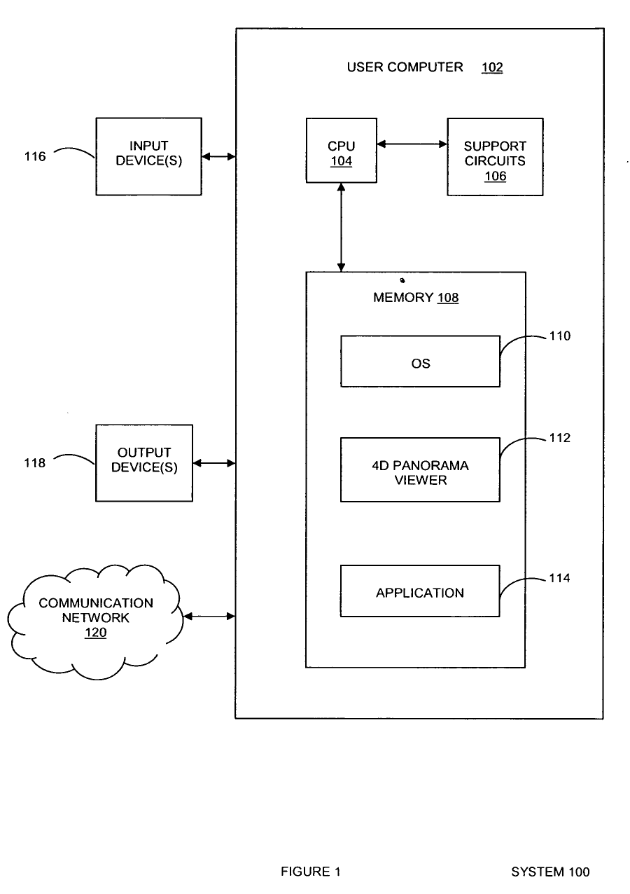

FIG. 1 is a block diagram of a computer system 100 according to embodiments of the present invention. The computer system 100 comprises a computer 102 that is capable of executing applications and which is connected to a communication network 120. The network 120 generally forms a portion of the Internet which may comprise various sub-networks such as Ethernet networks, local area networks, wide area networks, wireless networks, and the like. The computer 102 comprises, without limitation, input/output devices, such as an input device 116 and an output device 118, a CPU 104, support circuits 106, and a memory 108. The CPU 104 may be one or more of any commercially available microprocessors or microcontrollers. The support circuits 106 comprise circuits and devices that are used in support of the operation of the CPU 104. For example, the input device 116, the output device 118, the CPU 104, and the memory 108 are inter-connected through the support circuits 106. Such support circuits include, for example, cache, input/output circuits, communications circuits, clock circuits, power supplies, system bus, PCI bus and the like. Those skilled in the art will appreciate that the hardware depicted in the FIG. 1 may vary from one computer system to another. For example, other peripheral devices, such as optical disk drives, graphics card, data storage devices, various other input devices and the like, may also be used in addition to or in place of the hardware depicted.

The memory 108 may comprise random access memory, read only memory, optical memory, disk drives, removable memory, and the like. Various types of software processes or modules and information are resident within the memory 108. For example, various processes such as an Operating System (OS) kernel 110, a software library (not shown), and software modules, for example, 4D panorama Viewer modules 112, and Application module 114 are illustrated as being resident in the memory 108. Application module 114 may be any application of interest to the user of user computer 102.

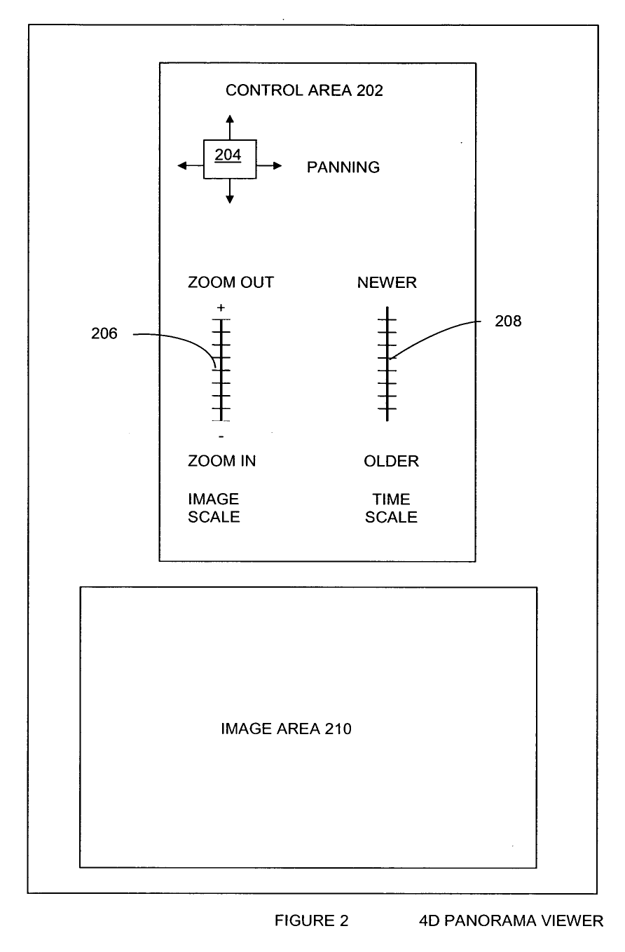

In one embodiment of the invention software module 112 (a 4D panorama viewer module) is stored in memory 108. The module 112 is a set of instructions executed by CPU 104 to perform a method in accordance with at least one embodiment of the present invention. The module 112 may be a stand alone software program or may be a portion of a larger program such as an internet browser. As depicted in FIG. 2 and according to aspects of the present invention, the module 112 comprises an control area entity 202 configured to allow a user to navigate through a panorama that may be displayed on a user's computer screen, and an image area entity 310 which facilitate the displaying of a panorama on the user's computer screen. The control area entity further comprises a panning control entity 304 to allow the user to navigate left or right, and up or down throughout the panorama, a zoom-in and zoom-out control entity 306, and a time scale (i.e. time dimension) entity 308 to allow the user to view images based on relative time of occurrence within the panorama.

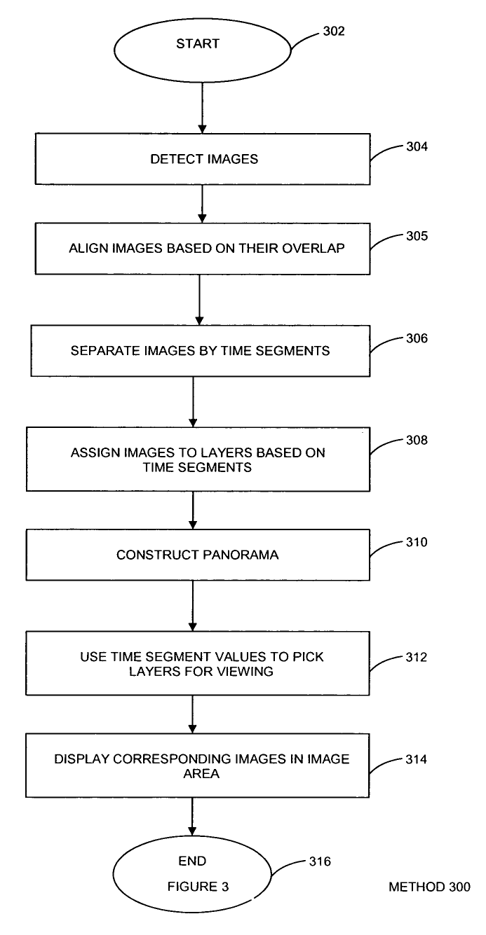

FIG. 3 is a flow chart of method 300 which may be used for constructing a 4D panorama viewer that comprises a time dimension control in accordance with the present invention. The method begins at step 302 and in step 304 images are detected. The images may be, for example, downloaded from the internet or uploaded from an input device. In step 305, overlapping (i.e., matching) images are aligned and in step 306 the aligned images are separated and grouped according to relative points in time in which a particular set of images may have been taken (i.e., recorded by some type of photographic device). To facilitate the time dimension control feature of the present invention, each relative point in time, with associated images, is assigned a value. The values then may be used to indicate and pick layers in a panorama, step 308. A panorama may now be constructed that comprises a time dimension control whereby values displayed on a time scale may be used to picked image portions of a panorama based on the relative time occurrence of the picked image portion, steps 310 and 312. In step 314, the selected portion of the panorama may now be displayed in the image area of the panorama on a user computer screen. The method ends at step 316.

Accordingly, in embodiments of the present invention, a panorama is comprised of a number of layers, with each layer corresponding to a point of time inside the interval during which the set of images are taken. Each layer is constructed by taking into account only the images taken at that time. The alignment of images taken at different times brings multiple layers into aligned positions.

Additionally, a panorama viewer in accordance with the present invention is comprised of an image area and a control area. The control area further comprises a time dimension control whereby a user may change values on a time dimension scale to pick corresponding layers to be displayed in the image area. By doing so, the user is able to focus on changes in the images of the panorama that occurred at different times.

While the foregoing is directed to embodiments of the present invention, other and further embodiments of the invention may be devised without departing from the basic scope thereof, and the scope thereof is determined by the claims that follow.

1. A method for constructing a panorama viewer comprising:
a. detecting panorama images
b. Aligning the images either manually or automatically
c. separating the images by time segments in which the images were recorded
d. assigning the images to layers based on the time segments
e. constructing a panorama comprised of the layers
f. constructing an image area to display the panorama
g. constructing a control area further comprising
i. an up control
ii. a down control
iii. a zoom in control
iv. a zoom out control
v. a right control
vi. a left control and
vii. a time dimension control.

2. A system for viewing a panorama comprising:
a. a panorama viewer that includes multiple layers with each layer corresponding to a point of time within an interval during which a set of images were taken;
b. an image area; and
c. a control area, the control area further comprising an up control, a down control, a zoom in control, a zoom out control, a left control, a right control, and a time dimension control.

3. The system of claim 2 wherein each layer is constructed by taking into account only the images corresponding to the point of time within an interval during which a set of images were taken.

4. The system of claim 2 wherein the time dimension control allows a user to select images throughout a panorama based on relative time of occurrence within the panorama.
